(19) United States
(12) Patent Application Publication
(10) Pub. No.: US 2007/0133046 A1
(43) Pub. Date: Jun. 14, 2007

(54) Printing Program, Printing Method, and Host Apparatus

(75) Inventor: Takashi Nagai, Suwa-shi, Nagano-ken (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/567,063

(22) Filed: Dec. 5, 2006

(30) Foreign Application Priority Data
Dec. 8, 2005 (JP) 2005-354912

(51) Int. Cl. G06F 3/12

(52) U.S. Cl. 358/1.15; 358/1.13

(57) ABSTRACT

A printing program allows a host apparatus to perform print request processing on a printer. The host apparatus includes at least one first file each storing a printing condition. The printing program allows the host apparatus to execute detecting a second file including an object to be printed and one of the at least one first file, the second file and the one first file being designated by a user; and issuing a print request for printing the detected second file under the printing condition stored in the detected first file to the printer.

### BACKGROUND

1. Technical Field

The present invention relates to printing programs for allowing host apparatuses to perform print request processing. More specifically, the invention relates to a printing program, a printing method, and a host apparatus in which highly flexible print request processing can be performed by an easy operation without placing a load on the host apparatus.

2. Related Art

In general, when a print object such as text and an image is printed from a host apparatus such as a personal computer, a printing instruction for creating and/or editing the print object is issued from an application installed in the host apparatus. In this case, a print request is issued by activating a driver for a printer specified in the printing instruction to generate print data for the printer according to the printing instruction and transmitting the print data to the printer.

Recently, printers capable of directly processing image files such as PDF, JPEG, TIFF files have become increasingly widespread. With the widespread of such printers, utility programs for directly transferring those files to the printers and issuing print requests are often installed into host apparatuses. The utility programs transfer files to be printed to the printers after performing some processing, such as adding header information regarding printing conditions, without performing conversion into print data for the printers, unlike the drivers.

A first utility program of the related art uses the function of folders provided by an operation system (OS) of a host apparatus. In this case, a list for associating the folders with printing conditions is provided. A user drops a print object file onto an icon of a predetermined folder on a display screen, thereby determining printing conditions according to the information of the list and issuing a print request to the printer to perform printing under the determined printing conditions when the print object file is transferred.

There is a second utility program of the related art in which a user directly drops a print object file onto an icon of that utility (program) on a display screen, thereby transferring the file and performing printing (see “CPS Sofuto Rippa Plus 2, Uzazu Gaido, PostScript Sofutouea Intapurita (CPS Soft Ripper Plus 2, User's Guide, PostScript Software Interpreter)”, Seiko Epson Corporation, 2004, p. 153). In this case, after a user performs such a drop operation, a window for designating printing conditions is displayed, and the file is transferred after the user has designated printing conditions.

However, there are problems with the first and second utility programs of the related art. In the first utility program of the related art, a print object file is dropped onto one of the folders provided by the OS. In order to detect a drop operation performed by the user, the utility program needs to constantly monitor the folders used for printing. The utility program therefore needs to be resident in a memory. Further, if the number of folders to be monitored is large, a large load is imposed on the host apparatus. Intermittent monitoring of the folders may cause the utility program to delay the start of print request processing with respect to the drop operation performed by the user. Moreover, it is necessary to change the names of the folders used for printing so as to match those in the list described above, which is inconvenient.

In the second utility program of the related art, when the user only drops a file onto the icon of the utility to start print request processing, the printing operation can only be performed under a series of predetermined printing conditions. As described above, a user designates printing conditions after the user has performed the drop operation, thus allowing the printing operation to be performed in a variety of manners. However, the user is forced to perform an input operation as well as the drop operation, which may result in low user-friendliness.

### SUMMARY

An advantage of some aspects of the invention is that it provides a printing program for allowing a host apparatus to perform print request processing, more specifically, a printing program, a printing method, and a host apparatus in which highly flexible print request processing can be performed by an easy operation without placing a load on the host apparatus.

According to an aspect of the invention, there is provided a printing program for allowing a host apparatus to perform print request processing on a printer. The host apparatus includes at least one first file each storing a printing condition. The printing program allowing the host apparatus to execute detecting a second file including an object to be printed and one of the at least one first file, the second file and the one first file being designated by a user; and issuing a print request for printing the detected second file under the printing condition stored in the detected first file to the printer.

It is preferable that the user designates the second file and one of the at least one first file by dropping an icon of the second file that is displayed by the host apparatus onto an icon of the one designated first file that is displayed by the host apparatus.

It is preferable that when the user drops the icon of the second file, location information of the second file is obtained without moving the second file itself,

It is preferable that the at least one first file has a unique identifier.

It is preferable that the printing program further allows the host apparatus to execute presenting an error indication to the user when the detected second file or the printing condition stored in the detected first file is not suitable for printing on the printer.

According to another aspect of the invention, there is provided a printing method for performing printing using a printer in response to print request processing performed on the printer by a host apparatus. The host apparatus includes at least one first file each storing a printing condition. The printing method includes detecting, by the host apparatus, a second file including an object to be printed and one of the at least one first file, the second file and the one first file being designated by a user; and issuing, by the host apparatus, a print request for printing the detected second file under the printing condition stored in the detected first file to the printer.

According to another aspect of the invention, there is provided a host apparatus for performing print request processing on a printer. The host apparatus includes at least one first file each storing a printing condition; a detection unit that detects a second file including an object to be printed and one of the at least one first file, the second file and the one first file being designated by a user; and a print request unit that issues a print request for printing the second file detected by the detection unit under the printing condition stored in the first file detected by the detection unit to the printer.

Further advantages and features of the invention will become apparent from the following description of exemplary embodiments of the invention.

### BRIEF DESCRIPTION OF THE DRAWINGS

The invention will be described with reference to the accompanying drawings, wherein like numbers reference like elements.

FIG. 1 is a block diagram showing a structure of a host apparatus according to an embodiment of the invention.

FIG. 2 is a conceptual block diagram showing a printing program according to an embodiment of the invention.

FIG. 3 is a flowchart showing a procedure of print request processing.

FIG. 4 is a diagram showing an example of a display screen 61 provided by the host computer 1.

### DESCRIPTION OF EXEMPLARY EMBODIMENTS

Preferred embodiments of the invention will be described with reference to the drawings. However, the technical scope of the invention is not limited by those embodiments. In the drawings, the same or similar elements are illustrated with the same reference numerals or reference symbols.

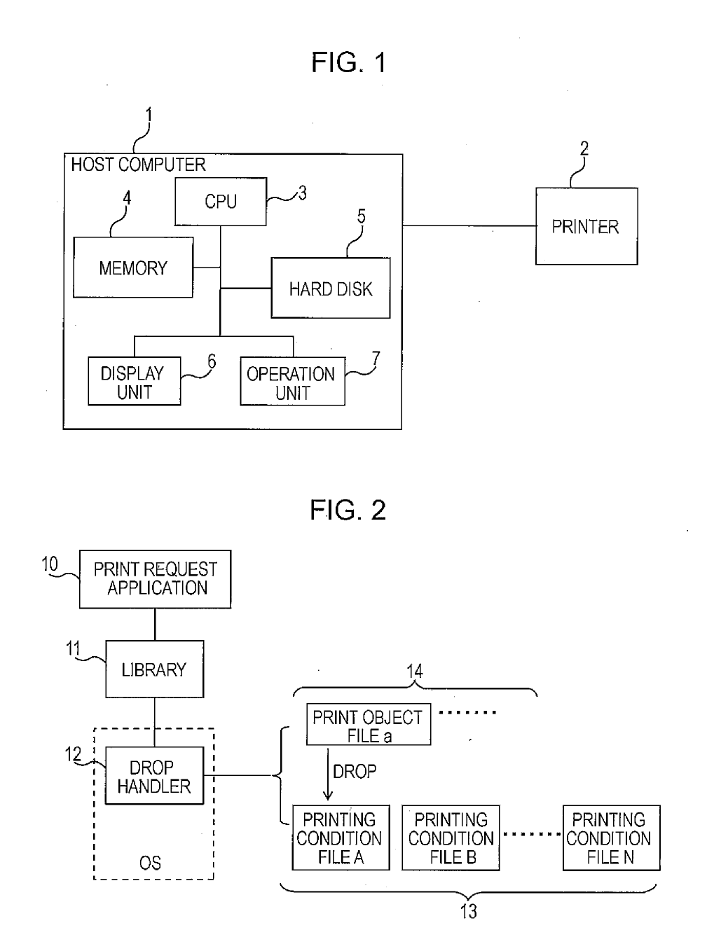

FIG. 1 is a block diagram of a host computer 1, which serves as a host apparatus according to an embodiment of the invention. FIG. 2 is a conceptual block diagram showing a printing program according to an embodiment of the invention. The host computer 1 shown in FIG. 1 serves as the host apparatus according to the embodiment. The host computer 1 includes the printing program according to the embodiment, which is implemented by a print request application 10 and a library 11 shown in FIG. 2. The host computer 1 further includes a plurality of printing condition files 13 each describing printing conditions. The host apparatus and printing program according to the embodiments are configured such that a user only drops a print object file 14 onto an icon of any of the printing condition files 13, thereby performing printing under the printing conditions desired by the user.

The host computer 1 is formed of a general-purpose personal computer or the like, and is connected to a printer 2 via a cable or a network. The printer 2 has a function capable of directly processing image files such as PDF, JPEG, and TIFF files so that the host computer 1 can transfer a print object file to issue a print request. As shown in FIG. 1, the host computer 1 includes a central processing unit (CPU) 3, a memory 4, a hard disk 5, a display unit 6, and an operation unit 7, which are typically included in a general-purpose personal computer.

The configuration of software implementing the print request function of the host computer 1, specifically, a function for directly transferring a print object file to the printer 2 to issue a print request, will now be described.

The print request application 10 shown in FIG. 2 is a program for issuing a print request to the printer 2. The print request application 10 is pre-installed in the host computer 1 and is stored in the hard disk 5. In response to a notification from the library 11 as described below, the print request application 10 is loaded into the memory 4 and is activated, and the print request processing is performed under control of the CPU 3 according to the program. The print request application 10, together with the library 11, implements the printing program installed in the host computer 1, and mainly functions to directly transfer the print object file 14 to the printer 2 to issue a print request, the details of which are discussed below.

The library 11 is a collection of functions used by other programs, and is also used by the print request application 10. The library 11 includes functions having various functions for performing printing using the printer 2. When a print request is issued, the function for detecting a printing instruction given by the user and notifying the print request application 10 is used. The library 11 is also pre-installed in the host computer 1 and is stored in the hard disk 5. When an event occurs, the library 11 is loaded into the memory 4.

A drop handler 12 represents a function provided by an operation system (OS) of the host computer 1, and detects and processes a drop operation in user events. In the host computer 1, an identifier (a character string for identifying the file type) of the printing condition files 13, which is discussed below, and a path of the library 11 are registered in the drop handler 12 in advance In other words, identification information of the printing condition files 13 for identifying them from other types of files and location information of the library 11 are registered in the drop handler 12 in advance. When a file is dropped onto one of the printing condition files 13, the drop handler 12 notifies the library 11 of the paths of the dropped file and the printing condition file 13 onto which the file has been dropped.

The printing condition files 13 are files in which printing conditions are described. As shown in FIG. 2, the host computer 1 includes one or more printing condition files A, B, . . . , N. The files A, B, . . . , N can store different printing conditions. For example, printing conditions relating to A4 monochrome printing are described in the printing condition file A, and printing conditions relating to A3 color printing are described in the printing condition file B. As described above, all the printing condition files 13 have a unique identifier different from other types of files. The printing condition files 13 are created in advance by the user, and are stored in the hard disk 5. In the printing condition files 13, printing conditions are described in, for example, the XML (extensible markup language) format. Further, the printing condition files 13 are displayed as icons 130 on the display unit 6 (a display screen 61) of the host computer 1 using the function of the OS.

The print object file 14 shown in FIG. 2 includes files to be printed by the printer 2, such as PDF, JPEG, and TIFF files, and is an object to be printed using the printing condition files 13, the library 11, and the print request application 10. The print object file 14 can be displayed on the display unit 6 (the display screen 61) as an icon 140. Once a user drops the icon 140 onto one of the printing condition files 13, the print object file 14 corresponding to the dropped icon 140 (e.g., a print object file a shown in FIG. 2) is printed. The print object file 14 is stored in the hard disk 5.

As described above, the host computer 1 has the print request application 10 and the library 11 installed therein in order to directly issue a print request based on the print object file 14, and also has one or more printing condition files 13 registered therein.

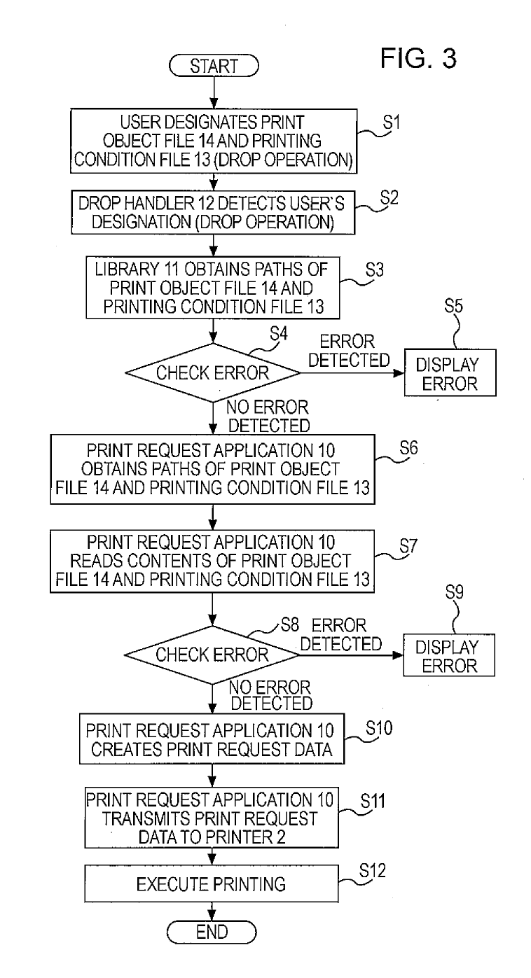

The details of the print request processing performed using the above-described software components will now be described. FIG. 3 is a flowchart showing a procedure for the host computer 1 to perform the print request processing. First, the user designates a file to be printed (the print object file 14) and printing conditions (one of the printing condition files 13) (step S1).

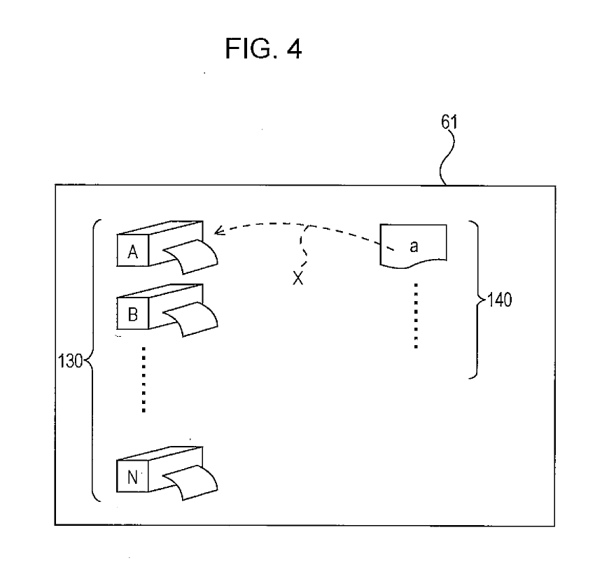

FIG. 4 illustrates an example of the display screen 61 provided by the host computer 1. On the display screen 61, the printing condition files 13 and the print object file 14 are represented as icons, and are displayed as the printing condition file icons 130 and the print object file icon 140, respectively. The printing condition file icons 130 include icons A, B. . . . , N, which correspond to the printing condition files A, B, . . . , N shown in FIG. 2. The print object file icon 140 includes an icon a, which corresponds to the print object file a shown in FIG. 2.

Specifically, the user designates the files (step S1) by dropping on the display screen 61 the icon 140 of the print object file 14 to be printed onto the icon 130 of one of the printing condition files 13 in which the desired printing conditions are stored. For example, on the display screen 61 shown in FIG. 4, the user uses a mouse or the like included in the operation unit 7 to move (or drag) and drop the print object file icon 140 (the icon a) to the printing condition file icon 130 (the icon A) (as indicated by an arrow x shown in FIG. 4). With that operation, the user can give an instruction to print the print object file a under the printing conditions described in the printing condition file A. Therefore, the host computer 1 has a large advantage in that a user can issue an instruction to perform printing under the desired printing conditions by performing the series of drag and drop actions described above. It is to be noted that the drag-and-drop operation does not cause the print object file 14 itself to move to the printing condition file 13 that is the drop destination.

When the user performs the designation (drop operation), the drop handler 12 detects it (step S2). Since the identifier of the file onto which the print object file 14 is dropped matches the pre-registered identifier of the printing condition files 13, the library 11 is notified of the paths (location information) of the dropped print object file 14 and the printing condition file 13 onto which the print object file 14 is dropped according to the registered path of the library 11. This can be efficiently performed because the printing condition files 13 have an identifier different from other types of files.

Upon receiving the notification, the library 11 obtains the paths of the print object file 14 and printing condition file 13 designated by the user (step S3), and checks for an error on both files (step S4). Specifically, for example, it is determined whether or not the print object file 14 is of the type supported by the printer 2. The error check is performed on the basis of, for example, the identifier of the print object file 14 using a predetermined function in the library 11. As a result of the check, if an error is detected, for example, if the dropped print object file 14 is of the type that is not supported by the printer 2, the library 11 presents an error indication to the user (step S5). Specifically, for example, a message indicating that the printing based on the user's designation is not allowed is displayed on the display screen 61.

If no error is detected, the library 11 notifies the print request application 10 of the obtained paths of the print object file 14 and the printing condition file 13, and the print request application 10 obtains those paths (step S6). Then, the print request application 10 reads the contents of the print object file 14 and the printing condition file 13 according to the obtained paths (step S7). That is, the data stored in the print object file 14, such as an image, and the description of the printing conditions stored in the printing condition file 13 are read.

Then, the print request application. 10 checks for an error (step S8). The error check is performed as to whether or not the printing condition file 13 is described in a predetermined format (e.g., the XML format), whether or not the printing conditions described in the printing condition file 13 are supported by the printer 2, whether or not the print object file 14 meets the printing conditions described in the printing condition file 13, and so forth. If any unsuitable item is found, an error is detected, and an error indication is provided (step S9). Specifically, for example, a message indicating that the printing based on the user's designation is not allowed is displayed on the display screen 61.

If no unsuitable item is found as a result of the check, no error is detected, and the print request application 10 creates print request data (step S10). The print request data includes the contents of the print object file 14, and the printing condition information described in the printing condition file 13. In the print request data creation process, processing such as converting data of the contents of the print object file 14, if necessary, and adding a header including the printing conditions, is performed.

Then, the print request application 10 transmits the created print request data to the printer 2 (step S11). The print request data is received by the printer 2, and the printer 2 performs a printing operation based on the print request data (step S12). Specifically, the contents of the print object file 14 designated by the user are printed under the printing conditions of the printing condition file 13 designated by the user. Thus, the print request processing performed by the host computer 1 and the printing operation in response to the print request processing are completed.

As described above, in the host computer 1 including the printing program according to the embodiment, the plurality of printing condition files 13 describing printing conditions are registered in advance. A user designates the print object file 14 and one of the printing condition files 13 that includes the desired printing conditions by performing a single drag-and-drop operation on the icons of those files on the display screen 61, and requests the printer 2 to perform printing according to the user's designation. Thus, once the user performs the above-described single operation, the user can give an instruction to perform printing under desired printing conditions from among various printing conditions. Highly flexible printing instruction processing can therefore be achieved with an easy operation.

The printing condition file 13 onto which the print object file 14 is dropped is assigned an identifier different from other types of files, and the identifier is registered in the OS so that once a file is dropped onto a file having that identifier, the printing program is notified of the dropped file and the file onto which the file is dropped There is no need for the printing program to monitor the printing condition files 13 that may be subjected to the drop operation, resulting in a low load on the host computer 1. It is therefore possible to register a large number of printing condition files 13 and to easily instruct printing under a wide variety of printing conditions. Since the printing program can be notified unless the identifier of the printing condition files 13 is changed, the user can freely change a file name.

While in the above-described embodiment, the printing program is implemented by the print request application 10 and the library 11, the printing program may be implemented as a single program without distinguishing between them. Further, the printing program according to the embodiment mainly aims to transfer the print object file 14 to the printer 2 to print it. However, like a printer driver, the print object file 14 may be converted into print data for the printer 2 and may then be transmitted. Also in that case, there is no change in the print request procedure described above with reference to FIG. 3.

The scope of the invention is not limited to the above-described embodiments, and all embodiments as defined by the appended claims and equivalent thereto fall within the scope of the invention.

The entire disclosure of Japanese Patent Application No. 2005-354912, filed Dec. 8, 2005 is expressly incorporated by reference herein.

What is claimed is:

1. A printing program for allowing a host apparatus to perform print request processing on a printer, the host apparatus including at least one first file each storing a printing condition, the printing program allowing the host apparatus to execute:
detecting a second file including an object to be printed and one of the at least one first file, the second file and the one first file being designated by a user; and
issuing a print request for printing the detected second file under the printing condition stored in the detected first file to the printer.

2. The printing program according to claim 1, wherein the user designates the second file and one of the at least one first file by dropping an icon of the second file that is displayed by the host apparatus onto an icon of the one designated first file that is displayed by the host apparatus.

3. The printing program according to claim 2, wherein when the user drops the icon of the second file, location information of the second file is obtained without moving the second file itself.

4. The printing program according to claim 1, wherein the at least one first file has a unique identifier.

5. The printing program according to claim 1, further allowing the host apparatus to execute presenting an error indication to the user when the detected second file or the printing condition stored in the detected first file is not suitable for printing on by the printer.

6. A printing method for performing printing using a printer in response to print request processing performed on the printer by a host apparatus, the host apparatus including at least one first file each storing a printing condition, the printing method comprising:
detecting, by the host apparatus, a second file including an object to be printed and one of the at least one first file, the second file and the one first file being designated by a user; and
issuing, by the host apparatus, a print request for printing the detected second file under the printing condition stored in the detected first file to the printer.

7. A host apparatus for performing print request processing on a printer, the host apparatus comprising:
at least one first file each storing a printing condition;
a detection unit that detects a second file including an object to be printed and one of the at least one first file, the second file and the one first file being designated by a user; and
a print request unit that issues a print request for printing the second file detected by the detection unit under the printing condition stored in the first file detected by the detection unit to the printer.
